(19) United States
(12) Patent Application Publication
(10) Pub. No.: US 2025/0196863 A1
(43) Pub. Date: Jun. 19, 2025

(54) GENERATING A ROAD-HEIGHT PROFILE

(71) Applicant: QUALCOMM Incorporated, San Diego, CA (US)

(72) Inventors: Nanzhi LARSSON, Linköping (SE); Johannes FRI, Linköping (SE); Oskar DANIELS, Linköping (SE); Caspian Adam Gabriel SUESSKIND, Linköping (SE); Edvin Carl Martin BERGSTROEM, Linköping (SE); Angui WEI, Linköping (SE); Mikael HARTMAN, Linköping (SE)

(21) Appl. No.: 18/538,980

(22) Filed: Dec. 13, 2023

(51) Int. Cl. B60W 40/072

(52) U.S. Cl. CPC B60W 40/072; B60W 2552/20

(57) ABSTRACT

Systems and techniques are described herein for determining height information of a road. For instance, a method for determining height information of a road is provided. The method may include obtaining a first road-height profile indicative of heights of a road at various depths; obtaining a depth representation of the road; determining a second road-height profile based on the depth representation of the road; and combining the first road-height profile and the second road-height profile to generate a third road-height profile.

### TECHNICAL FIELD

The present disclosure generally relates to autonomous, semi-autonomous, or assisted driving. For example, aspects of the present disclosure include systems and techniques for generating a road-height profile for a driving system (e.g., an autonomous, semi-autonomous, or assisted driving system).

### BACKGROUND

Some techniques determine information regarding a position of a road relative to a vehicle which is travelling on the road. It may be important for a driving system (e.g., an autonomous, semi-autonomous, or assisted driving system) to have accurate information regarding a position of a vehicle (e.g., a vehicle controlled by the driving system) relative to a road on which the vehicle is traveling.

In some cases, techniques may determine horizontal position information indicative of the position of the road in horizontal (e.g., side to side) dimensions as the road extends in front of the vehicle. For example, the horizontal position information may indicate a relative position of a center of a lane (or lane edges) as a function of depth from immediately in front of the vehicle to a depth (e.g., 50 meters) in front of the vehicle. Additionally, some techniques determine height information indicative vertical aspects of the road (e.g., inclines and/or declines).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for determining height information of a road. According to at least one example, a method is provided for determining height information of a road. The method includes: obtaining a first road-height profile indicative of heights of a road at various depths; obtaining a depth representation of the road; determining a second road-height profile based on the depth representation of the road; and combining the first road-height profile and the second road-height profile to generate a third road-height profile.

In another example, an apparatus for determining height information of a road is provided that includes at least one memory and at least one processor (e.g., configured in circuitry) coupled to the at least one memory. The at least one processor configured to: obtain a first road-height profile indicative of heights of a road at various depths; obtain a depth representation of the road; determine a second road-height profile based on the depth representation of the road; and combine the first road-height profile and the second road-height profile to generate a third road-height profile.

In another example, a non-transitory computer-readable medium is provided that has stored thereon instructions that, when executed by one or more processors, cause the one or more processors to: obtain a first road-height profile indicative of heights of a road at various depths; obtain a depth representation of the road; determine a second road-height profile based on the depth representation of the road; and combine the first road-height profile and the second road-height profile to generate a third road-height profile.

In another example, an apparatus for determining height information of a road is provided. The apparatus includes: means for obtaining a first road-height profile indicative of heights of a road at various depths; means for obtaining a depth representation of the road; means for determining a second road-height profile based on the depth representation of the road; and means for combining the first road-height profile and the second road-height profile to generate a third road-height profile.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example system that may generate a road-height profile, according to various aspects of the present disclosure;

FIG. 2 includes an example image and an example graph illustrating a road-height profile, according to various aspects of the present disclosure;

FIG. 3 includes a simulated image of a road overlaid with visual representations of lane boundaries, a bird's-eye-view representation of the road, and a graph illustrating a road-height profile, according to various aspects of the present disclosure;

FIG. 4 includes two images illustrating an example scenarios in which parallel-lane-assumption-based road-height-profile estimation may provide an inaccurate road height;

FIG. 5 is a diagram illustrating an example projection-based depth-estimation system, according to various aspects of the present disclosure;

FIG. 6 illustrates two example images, that may be used to determine depth information according to a depth-from-stereo (DFS) depth-estimation technique;

FIG. 7 illustrates two example images and an example associated cost function, according to various aspects of the present disclosure;

FIG. 8 illustrates a scenario in which a camera captures a first image of a scene at a first time and a second image of scene at a second time;

FIG. 9 is a block diagram illustrating an example system 900 that may generate a road-height profile based on a depth representation, according to various aspects of the present disclosure;

FIG. 10 includes an example image of a road, a graph illustrating a various height values, and a graph illustrating various height values 1016 and a road-height profile 1014, according to various aspects of the present disclosure;

FIG. 11 is a flow diagram illustrating an example process for combining a first road-height profile and a second road-height profile, according to various aspects of the present disclosure;

FIG. 12 includes a simulated image of a road overlaid with visual representations of lane boundaries, a bird's-eye-view representation of the road, and a graph illustrating a road-height profile, according to various aspects of the present disclosure;

FIG. 13 is a flow diagram illustrating another example process for generating a road-height profile, in accordance with aspects of the present disclosure;

FIG. 14 is a block diagram illustrating an example of a deep learning neural network that can be used to perform various tasks, according to some aspects of the disclosed technology;

FIG. 15 is a block diagram illustrating an example of a convolutional neural network (CNN), according to various aspects of the present disclosure; and

FIG. 16 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

In order for a vehicle to travel on a road, it may be important for a driving system (e.g., an autonomous, semi-autonomous, or assisted driving system) to have accurate information regarding the road, including horizontal information and vertical information. The horizontal information may include information describing the road in a horizontal plane, for example, describing turns or curves in the road, such as from a bird's-eye-view (BEV) of the road. The vertical information may include information describing vertical aspects of the road, for example, inclines and/or declines in the road (e.g., hills or valleys). Vertical information can be important for a driving system of the vehicle to use for correctly projecting objects detected in frames captured by one or more sensor(s) (e.g., camera(s), etc.) to a world position on the road surface. Incorrect vertical information may result in inaccurate projection of objects, which may then result in incorrect autonomous steering.

Systems, apparatuses, methods (also referred to as processes), and computer-readable media (collectively referred to herein as “systems and techniques”) are described herein for generating a road-height profile. For example, a road-height profile may describe or represent vertical information of a road. According to some aspects, the systems and techniques described herein may obtain a first road-height profile. The first road-height profile may be determined according to a parallel-lane assumption. For example, the first road-height profile may be determined by capturing an image of the road, assuming that the lane boundaries of a lane are parallel, and calculating a height of the lane based on the image and the lane boundaries in the image. The systems and techniques may further obtain a second road-height profile. The second road-height profile may be based on a depth representation of the road. For example, the systems and techniques may determine a depth representation of the road using a depth-estimation technique and/or depth sensor. The systems and techniques may determine the second road-height profile based on the depth representation, for example, by modeling the second road-height profile based on depth points of the depth representation that represent the road. The systems and techniques may combine the first road-height profile and the second road-height profile to obtain a third road-height profile. The third road-height profile may exhibit advantages of the first road-height profile and advantages of the second road-height profile.

A road-height profile based on the parallel-lane assumption (e.g., the first road-height profile) may be generally accurate. For example, calculating a vertical height of a road based on the position of a lane in an image (where the lane has a known width) may result in accurate height information. However, there are many cases in which the parallel-lane assumption may not apply, for example, when lanes merge or divide, when lane markings are changed due to construction, and/or when lane markings are not visible, for example, due to weather conditions. In such cases, a road-height profile based on the parallel-lane assumption may be inaccurate or unavailable.

A road-height profile based on a depth representation (e.g., the second road-height profile) may be more available than a road-height profile based on the parallel-lane assumption. For example, a vehicle may almost always be able to generate depth representations and determine a road-height profile based on the depth representation.

The systems and techniques may generate the third road-height profile to have accuracy by using the first road-height profile and availability by using the second road-height profile. Thus, the systems and techniques may combine the advantages of road-height profiles based on the parallel-lane assumption and road-height profiles determined based on depth representations.

It is important for driving systems (e.g., autonomous, semi-autonomous, or assisted driving systems) of vehicles to have accurate road information, including horizontal and vertical information. These capabilities may become even more important for higher levels of autonomy, such as autonomy levels 3 and higher. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions own. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles fully autonomous, self-driving vehicles that operate autonomously in all conditions. A human operator is not needed for the vehicle to take any action. Thus, autonomous, semi-autonomous, or assisted driving systems are an example of where the systems and techniques described may be employed. Also, the systems and techniques may be employed in non-autonomous (e.g., human controlled) vehicles. For example, the systems and techniques may provide information regarding road information to a driver.

Various aspects of the application will be described with respect to the figures below.

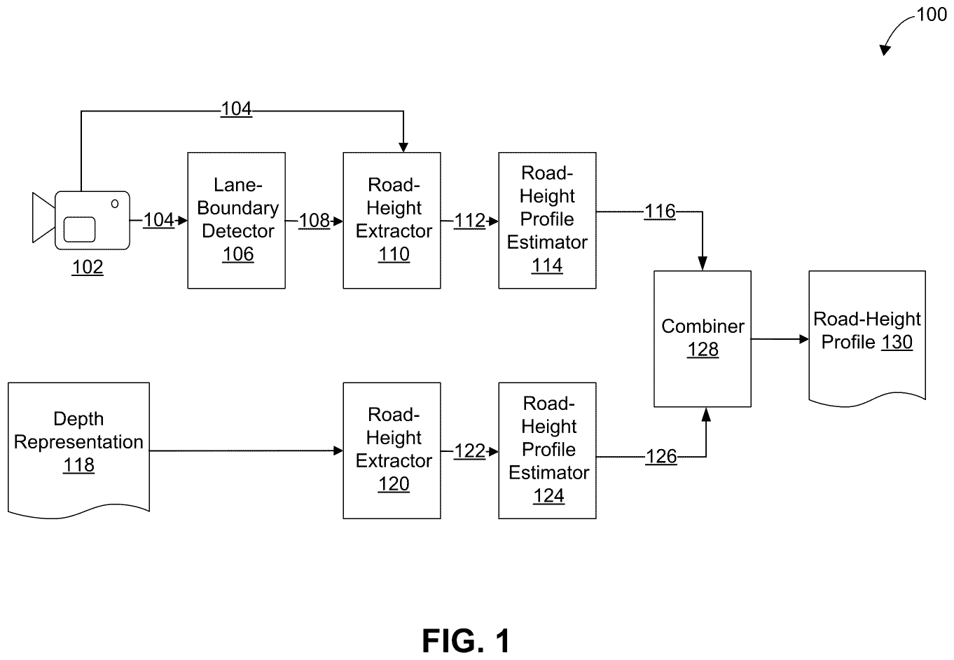

FIG. 1 is a block diagram illustrating an example system 100 that may generate a road-height profile 130, according to various aspects of the present disclosure. For example, system 100 may obtain two road-height profiles (e.g., road-height profile 116 and road-height profile 126) and use combiner 128 to combine the two road-height profiles to generate road-height profile 130.

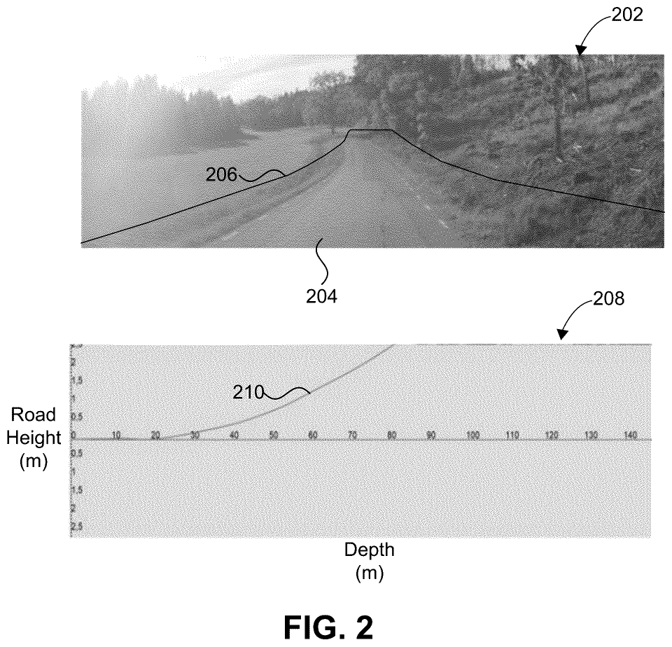

FIG. 2 includes an example graph 208 illustrating a road-height profile 210. For example, FIG. 2 includes an image 202 of a road 204. Image 202 may be captured by a camera on a vehicle. Image 202 may be an image of road 204 in front of the vehicle. For example, the camera may be facing in the direction in which the vehicle is traveling on road 204. Graph 208 illustrates height information for road 204. In particular, graph 208 illustrates road-height profile 210 which includes height values for each of a number of depths.

In the present disclosure, the term “depth” may refer to a distance in front of a device (e.g., a camera of a vehicle or the vehicle itself). For example, a depth of zero meters may be directly at the device (or directly beneath the device) and a depth of 10 meters may be 10 meters in front of the device. In the art, depth may alternatively be referred to as distance, or referenced as longitudinal distance.

In the present disclosure, the term “height” may refer to a measure in a vertical dimension. Height may be relative to a current height of the device, the vehicle, or the road. For example, a height of road 204 at 40 meters depth may be 0.5 meters higher than a current height of road 204 and a height of road 204 at 60 meters depth may be 1.1 meters higher than a current height of road 204. Road-height profile 210 may be, or may include, discrete height values corresponding to a number of depths. Alternatively, road-height profile 210 may be, or may include, a continuous function indicative of a height of road 204 for any depth up to a depth (e.g., as far away as the technique which generated the height can estimate height values).

Projected road-height profile 206 is road-height profile 210 as projected onto image 202. An autonomous, semi-autonomous, or assisted driving system may generate a three-dimensional map of road 204 based, at least in part on road-height profile 210. Projected road-height profile 206 is a representation of how road-height profile 210 may look if projected into image 202, for example, which may be similar to how a vertical dimension of road 204 may be represented in a three-dimensional map of road 204.

Returning to FIG. 1, system 100 includes two examples of generating respective road-height profiles. For example, road-height profile 116 may be generated based on image data 104 and road-height profile 126 may be generated based on depth representation 118.

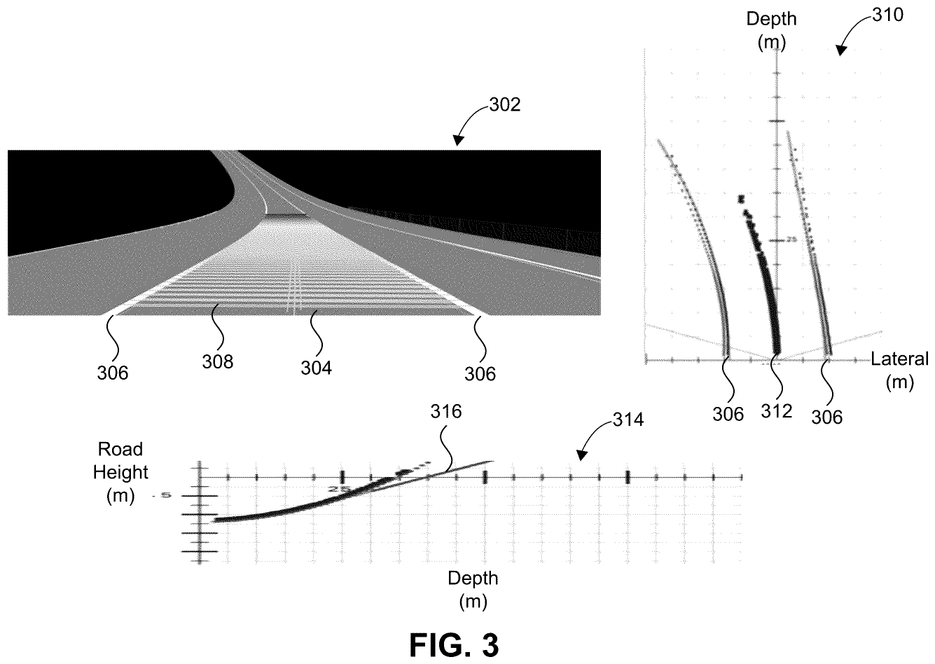

In some cases, system 100 may include a camera 102 that may generate image data 104. In other cases, system 100 may obtain image data 104 from camera 102 which may be external to system 100. In any case, lane-boundary detector 106 of system 100 may determine lane boundaries 108 based on image data 104. Lane boundaries 108 may be, or may include, image coordinates (relative to image data 104) of edges of lanes (including a lane in which a vehicle bearing camera 102 is travelling). Road-height extractor 110 of system 100 may determine road-height values 112 based on lane boundaries 108 and image data 104. Road-height profile estimator 114 may generate road-height profile 116 based on road-height values 112. Examples and additional details regarding lane-boundary detector 106, lane boundaries 108, road-height extractor 110, road-height values 112, road-height profile estimator 114, and road-height profile 116 are provided with regard to FIG. 3.

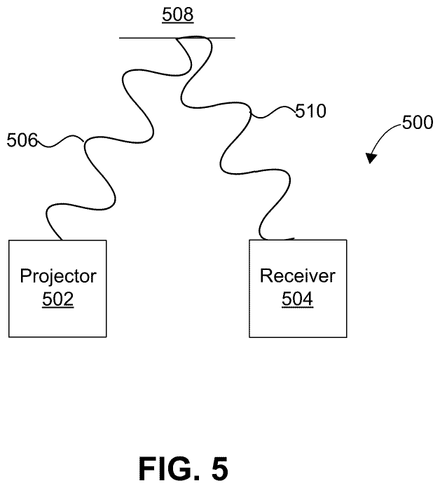

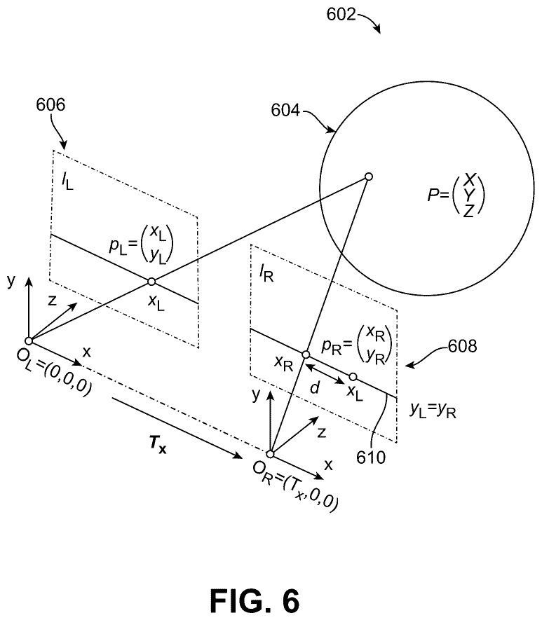

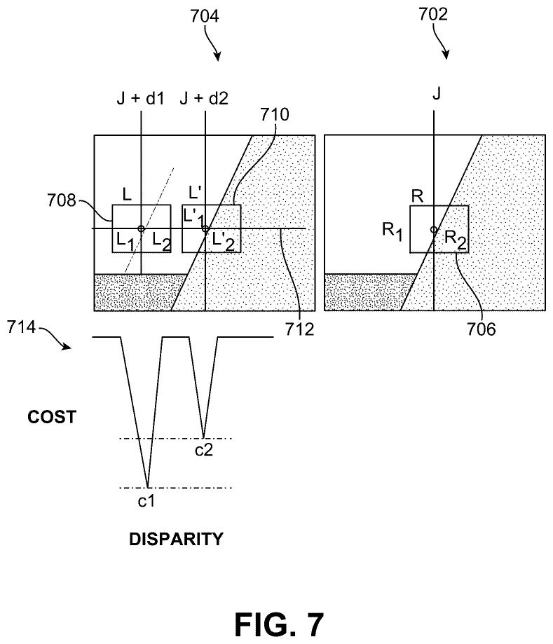

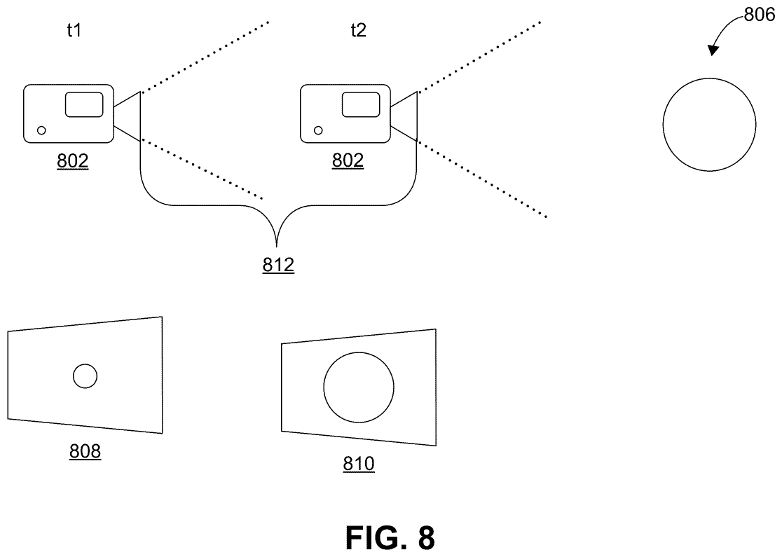

Depth representation 118 may be, or may include, a three-dimensional representation of the environment of a vehicle, including the road on which the vehicle is traveling. Depth representation 118 may be, or may include, a depth map including a number of depth values corresponding to a number of depth pixels. Additionally or alternatively, depth representation 118 may be, or may include, a point cloud including a number of three-dimensional coordinates. Depth representation 118 may be generated based on a radio detection and ranging (RADAR)-based representation the environment, a light detection and ranging (LIDAR)-based representation the environment, and/or a time of flight (ToF) depth-detection-based representation the environment (e.g., as described with regard to FIG. 5). As another example, depth representation 902 may be generated based on a stereoscopic depth-estimation-based representation the environment (e.g., as described with regard to FIG. 6, FIG. 7, and/or FIG. 8), a monocular vision depth-estimation-based representation the environment, and/or a geometric depth-estimation-based representation the road (e.g., as described with regard to FIG. 8).

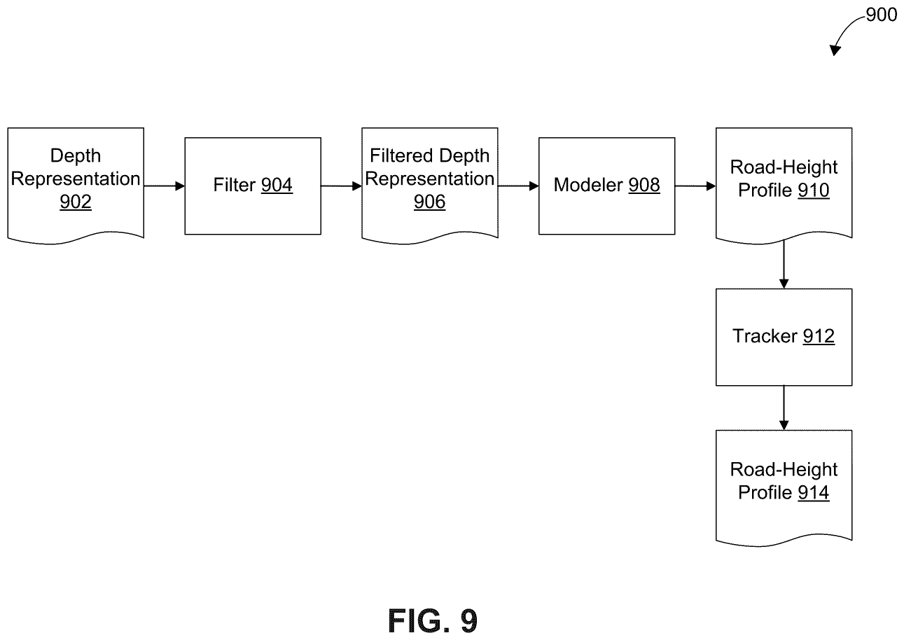

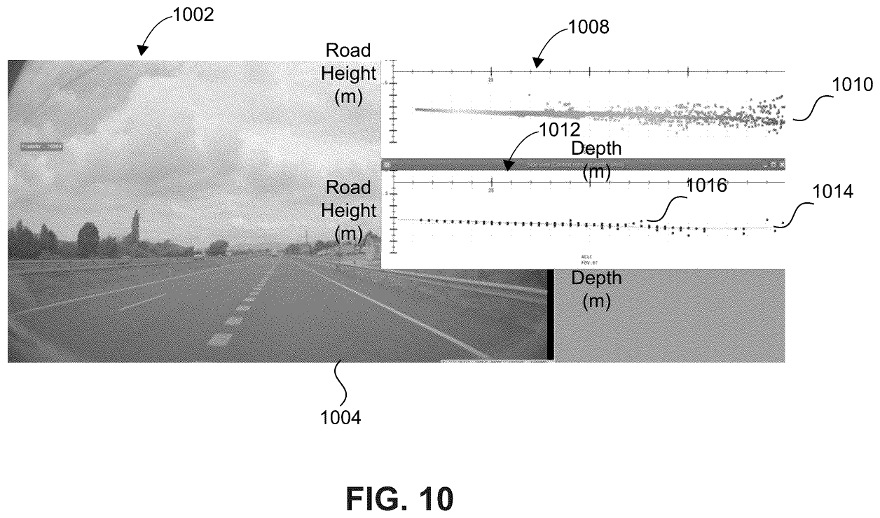

Road-height extractor 120 may generate road-height values 122 based on depth representation 118, for example, by extracting road-height values 112 from depth representation 118. Road-height profile estimator 124 may generate road-height profile 126 based on road-height values 122, for example, by modeling road-height profile 126 based on road-height values 122. Examples and additional details regarding depth representation 118, are provided with regard to FIG. 5, FIG. 6, FIG. 7, and FIG. 8. Examples and additional details regarding road-height extractor 120, road-height values 122, road-height profile estimator 124, and road-height profile 126 are provided with regard to FIG. 9 and FIG. 10.

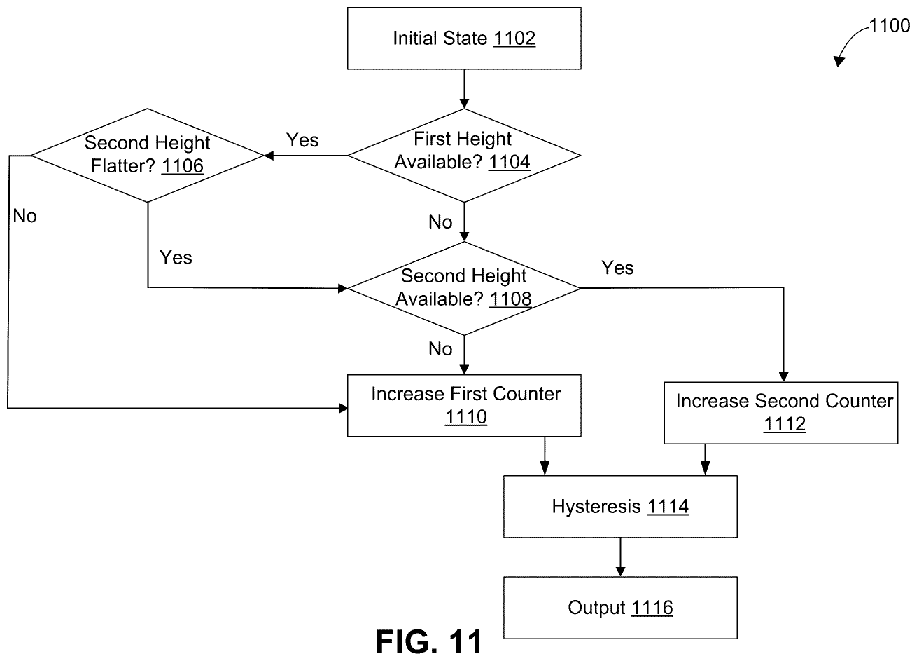

Combiner 128 may generate road-height profile 130 based on road-height profile 116 and road-height profile 126. Examples and additional details regarding road-height profile 130 are provided with regard to FIG. 11.

FIG. 3 includes a simulated image 302. Simulated image 302 include a lane 304. Simulated image 302 is overlaid with visual representations of lane boundaries 306. Lane boundaries 306 may be, or may include, image coordinates (of simulated image 302) indicative of edges of lane 304. Lane-boundary detector 106 of FIG. 1 may determine lane boundaries 306 based on simulated image 302.

In some aspects, lane-boundary detector 106 may be, or may include, a machine-learning model trained to determine lane boundaries based on images. For example, lane-boundary detector 106 may be trained through an iterative backpropagation training process. For example, a corpus of training data may include a number of images of roads annotated with lane boundaries (e.g., pixel coordinates representative of edges of lanes). Lane-boundary detector 106 may predict lane boundaries based on the images of the training data. The predicted lane boundaries may be compared to the lane boundaries of the annotations of the training data. Loss data, indicative of a difference between the predicted lane boundaries and the lane boundaries of the annotations of the training data may be determined. Parameters (e.g., weights) of lane-boundary detector 106 may be adjusted based on the loss data such that in future iterations of the training process lane-boundary detector 106 generates lane boundaries that are closer to the lane boundaries of the annotations of the training data. After a number of iterations of the training process, lane-boundary detector 106 may be deployed and may generate lane boundaries 108 based on image data 104.

Returning to FIG. 3, simulated image 302 is also overlaid with lines 308. Lines 308 may be horizontal (from the perspective of simulated image 302) lines between lane boundaries 306. For example, lines 308 may be parallel to a bottom edge of simulated image 302. Road-height extractor 110 of FIG. 1 may use lines 308 (or lane boundaries 306 corresponding to lines 308) to determine heights of points on lane 304. Road-height extractor 110 may apply a parallel-lane assumption and assume that lane edges (e.g., the lane edges in the real world on which lane boundaries 306 are based and/or lane boundaries 306 as projected into a three-dimensional environment) are substantially parallel and/or equidistant from each other. For example, road-height extractor 110 may assume that lane 304, in the real world, has a constant width. Based on the parallel-lane assumption, road-height extractor 110 may assume that lines 308, when projected into a three-dimensional environment, all have the same length.

Bird's-eye-view representation 310 is a bird's-eye-view representation of lane 304. Bird's-eye-view representation 310 includes lane boundaries 306. Bird's-eye-view representation 310 also includes lane center 312. Lane center 312 may be, or may include, a line or points based on centers of lines 308.

For a pinhole camera the depth (X) of each of lines 308 may be determined according to:

$$X = ( LaneWidthInMeters * CameraFocalLength ) / LaneWidthInPixels$$

where the Lane WidthInMeters is a constant based on the parallel-lane assumption;
where the CameraFocalLength is a known parameter of the camera which captured the image simulated by simulated image 302; and
where Lane WidthInPixels is a length of a respective one of lines 308 in simulated image 302.

A 3D position corresponding to each of lane center 312 (each of which corresponds to a respective one of lines 308) in relation to the camera can then be calculated based on X and calibration information. The depth and height of the 3D positions can then be used for road height profile estimation. For example, road-height extractor 110 may determine road-height profile 316 (illustrated in graph 314) based on the 3D positions of lane centers 312.

Parallel-lane-assumption-based road-height profile estimation (e.g., as described with regard to lane-boundary detector 106, road-height extractor 110, and road-height profile estimator 114 of FIG. 1, and lane boundaries 306, lines 308, lane center 312, and road-height profile 316 of FIG. 3) may provide accurate estimation of road height when the parallel-lane assumption applies. But a parallel-lane-assumption-based road-height-profile estimation may be sensitive to poor lane boundary detection (e.g., due to roads without lane markings, degraded lane-marking quality, guardrail shadows, tar marks, a curvy road, weather conditions, snow-covered roads etc.) Thus, parallel-lane-assumption-based road-height-profile estimation may exhibit low availability.

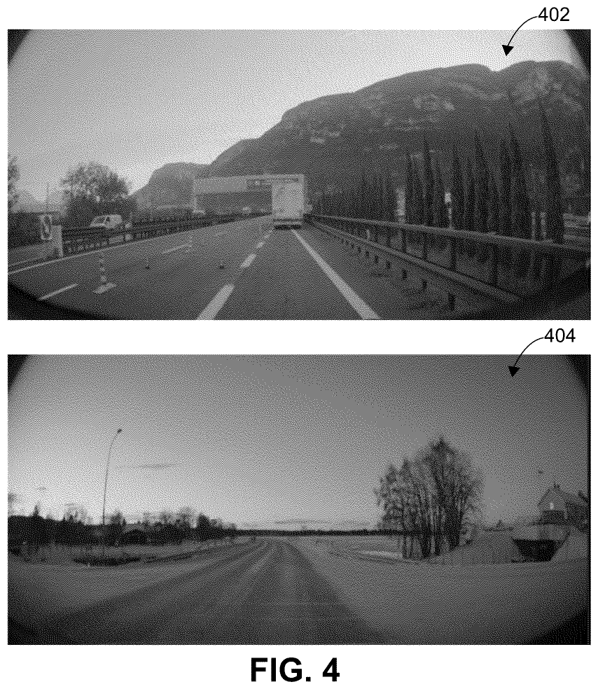

For example, FIG. 4 includes an image 402 illustrating an example scenario in which lanes have been adjusted to due construction and lane markings do not reflect driving conditions on the road. As another example, FIG. 4 includes an image 404 illustrating an example scenario in which lane lines have been covered by snow. In scenarios such as those illustrated by image 402 and image 404, parallel-lane-assumption-based road-height-profile estimation may provide an inaccurate road height, an indication that the road height is invalid or should be treated with low confidence, or no road height at all.

FIG. 5 is a diagram illustrating an example projection-based depth-estimation system (system 500), according to various aspects of the present disclosure. System 500 may generate depth representation 118 of FIG. 1. System 500 may be, or may include, for example, a light ranging and detection (LIDAR)-based system, a radio detection and ranging (RADAR)-based system a direct time-of-flight (DToF) system or an indirect time-of-flight (IToF) system.

As a LIDAR system, a RADAR system, or a dToF depth system, system 500 may measure a timing difference (e.g., a time of flight) between when emitted light pulse 506 is emitted by projector 502 and when reflected light pulse 510 received by receiver 504 (e.g., after emitted light pulse 506 has been reflected by object 508 in an environment). Although illustrated as spread apart in FIG. 5, projector 502 and receiver 504 may be collocated, beside one another, or interspersed with one another. As a LIDAR system, a RADAR system, or a dToF depth system, system 500 may, based on the time of flight and the speed of light, calculate a distance between the system 500 and object 508 in the environment. As used here, the term “light” may refer to any portion of the electromagnetic spectrum including, as examples, visible light, infrared light, and/or radio waves.

As an iToF depth camera, System 500 may measure a phase difference between emitted light pulse 506 as emitted by projector 502 and reflected light pulse 510 as received by receiver 504. System 500 may relate the phase difference to a time of flight of emitted light pulse 506 between emission and reception, based on the speed of light and the frequency of the light pulse. As an iToF depth camera, System 500 may, based on the time of flight and the speed of light, calculate a distance between system 500 and object 508 in the environment.

System 500 may emit one more light pulses into the environment and determine depth information relative to the environment. For example, projector 502 may emit one or more light pulses and receive and focus reflected light pulses onto an array of sensors of receiver 504. The array of depth sensors may include a number of independent depth sensors arranged as depth pixels. Each depth pixel may correspond to a ray between the depth pixel and the environment. For example, reflections along a given ray may be focused onto a given depth pixel. System 500 may store depth information recorded by various sensors as depth values of depth pixels of a depth map. Additionally or alternatively, system 500 may store depth information as a plurality of three-dimensional depth values, for example, of a point cloud.

Additionally or alternatively, projector 502 and receiver 504 may scan the environment. For example, projector 502 may project emitted light pulse 506 into the environment at a given angle and receiver 504 may receive reflected light pulse 510 from the environment. Projector 502 may change angles, for example, scanning the environment, and receiver 504 may track reflected light pulse 510 from various angles of projector 502. System 500 may store depth information from various angles as depth values of depth pixels of a depth map. Additionally or alternatively, system 500 may store depth information as a plurality of three-dimensional depth values, for example, of a point cloud.

Depth representation 118 of FIG. 1 may be an example of a depth map generated by system 500.

FIG. 6 illustrates two example images, that may be used to determine depth information according to a depth-from-stereo (DFS) depth-estimation technique. Depth representation 118 of FIG. 1 may be generated according to the principles described with regard to FIG. 6 and FIG. 7.

FIG. 6 illustrates image 606 and image 608 (also denoted in FIG. 6 as image I_{L} and image IR), of a single scene 602 captured from different camera positions, according to various aspects of the present disclosure. The different camera positions are marked as left and right “origin” points, O_{L} and O_{R}, which are offset by a distance Tₓ. Because of the offset Tₓ, the same point P of object 604 appears at different pixel locations p_{L} and p_{R} within the two images 606 (I_{L}.) and 608 (I_{R}). As can be seen, the x-axis coordinate x_{R} in image 608 (I_{R}), corresponding to point PR in image 608 (I_{R}), is offset along epi-polar line 610 by disparity d from a coordinate x_{L}, where the coordinate x_{L} corresponds to the position of the point P in the image 606 (I_{L}). This disparity in pixel locations (also referred to as discrepancy) may be used to determine an approximate distance from the cameras to the point P on object 604 in scene 602. By knowing the stereo camera geometry and applying such an analysis to each point in the images, a depth map of the scene may be generated.

In order to determine the disparity d, a system may determine that the pixel location p_{R} in the image 608 (I_{R}) corresponds to the pixel location p_{L} in the image 606 (I_{L}), for example, by comparing a window of pixels including pixels at, and around, the pixel location p_{L} to a number of windows of pixels in image 608 (I_{R}). An example of such a window-based comparison technique is described with respect to FIG. 7. For example, a passive stereo-vision system may determine epi-polar line 610 in the image 608 (I_{R}). Epi-polar line 610 may be a defined by a ray projected from origin point O_{L}, to the point P as viewed in in the image 606 (I_{R}). The passive stereo-vision system may compare the window of pixels including pixels at, and around, the pixel location p_{L} to similarly-sized windows along epi-polar line 610.

FIG. 7 illustrates two example images, image 702 (which may be a “right image” or a “reference image”) and image 704 (which may be a “left image”), and an example associated cost function 714, according to various aspects of the present disclosure. To compare windows between image 702 and image 704, a window 706 of pixels from the image 702 may be selected. Window 706 of pixels from image 702 may be compared to one or more windows of pixels from image 704. In some cases, window 706 may be compared to similarly-sized windows (e.g., all similarly-sized windows) along an epi-polar line 712 of image 704.

The cost function 714 shown in FIG. 7 is representative of a similarity between window 706 and similarly-sized windows along epi-polar line 712 of image 704 as a function of disparity. The similarity between windows may be based on similarities between respective red, green, blue, and/or intensity (or brightness or luminance) values of pixels included in the respective windows. The lower the value of cost function 714 for a particular disparity, the higher the degree of similarity is between window 706 and a window of image 702 at the corresponding disparity. For example, cost function 714 includes two minima, c1 and c2. The minima c1 corresponds to a disparity d1, which corresponds to a comparison between window 706 and candidate window 708 of image 704. The minima c2 corresponds to a disparity d2 which corresponds to a comparison between window 706 and candidate window 710 of image 704.

A disparity map may be a two-dimensional map of disparities. The two-dimensional map may relate to an image (e.g., image 606 of FIG. 6). For instance, a two-dimensional disparity map may include a resolution that is the same (or substantially the same in some cases) as a corresponding image, with a respective disparity value for each pixel of the image. In one illustrative example, a disparity map may be generated by determining a respective disparity for each pixel of a number of pixels (e.g., all, or most, of the pixels) of an image (e.g., by scanning windows across epi-polar lines of a stereoscopically-paired image and determining a disparity for each of the number of pixels). Each value of the disparity map may represent a disparity (e.g., disparity d of FIG. 6). A depth map may be derived from a disparity map based on the three-dimensional geometry of a scene (e.g., scene 602 of FIG. 6) including a distance between the cameras which captured the images (e.g., the distance T_{X} of FIG. 6).

A depth map may be a representation of three-dimensional information (e.g., depth information). For example, a depth map may be a two-dimensional map of values (e.g., pixel values) representing depths. The values of the depth map may correspond to pixels in a corresponding image (e.g., image 606 of FIG. 6). For instance, the depth map may have a resolution that is the same or substantially the same as the corresponding image, with each depth value of the depth map representing a depth, or distance, between an origin point (e.g., origin point O_{L} of FIG. 6) and points (e.g., point P of FIG. 6). In some cases, each pixel in the depth map may have one depth value. Because a depth map is based on a disparity map, in some cases, each pixel of a disparity may have one disparity. Additionally or alternatively, the depth information may be stored as a plurality of three-dimensional depth values, for example, of a point cloud.

Depth representation 118 of FIG. 1 may be an example of a depth map generated according to the principles described with regard to FIG. 6 and FIG. 7.

The principles described with regard to FIG. 6 and FIG. 7 can be applied to sequential image frames. For example, FIG. 8 illustrates a scenario in which a camera 802 captures a first image 808 of a scene 806 at a first time (t1) and a second image 810 of scene 806 at a second time (t2). Between t1 and t2, camera 802 travels distance 812.

As described with regard to FIG. 6 and FIG. 7, 3D positions of matched points of the sequential images (e.g., first image 808 and second image 810), may be triangulated using the motion of camera 802 (e.g., distance 812) as a baseline. Matching points can, for instance, be found by computing the binocular disparity between the two images. Motion of the camera can be determined using, for example, visual odometry, measured odometry, location services, etc. The disparity or depth information of pixels (e.g., between matching points in first image 808 and second image 810) can be used to calculate corresponding 3D positions.

For example, for a pinhole camera with known principal point position (principal_row, principal_column) in the image, given a pixel with position (row, column) in the image, based on its depth (x) information, D position (x, y, z) in relation to the camera can be calculated according to the following equation:

$$z = - ( row - principal\_row ) / CameraFocalLength * x$$

where z is height;
where CameraFocalLength is a known parameter of camera 802.

Depth representation 118 of FIG. 1 may be generated according to the principles described with regard to FIG. 8. In some aspects, depth representation 118 may be, or may include, a depth map of depth values arranged as depth pixels. Additionally or alternatively, depth representation 118 may store depth information as a plurality of three-dimensional depth values, for example, of a point cloud.

FIG. 9 is a block diagram illustrating an example system 900 that may generate a road-height profile 914 based on a depth representation 902, according to various aspects of the present disclosure. System 900 may be implemented by system 100 in generating road-height profile 126 based on depth representation 118. For example, filter 904, modeler 908, and/or tracker 912 of system 900 may be implemented by road-height extractor 120 and/or road-height profile estimator 124 of system 100.

Depth representation 902 may be a three-dimensional representation of an environment including a road. Depth representation 902 may be generated according to any suitable technique and/or using any suitable sensors or equipment. For example, depth representation 902 may be generated based on a radio detection and ranging (RADAR)-based representation the environment, a light detection and ranging (LIDAR)-based representation the environment, and/or a time of flight (ToF) depth-detection-based representation the environment (e.g., as described with regard to FIG. 5). As another example, depth representation 902 may be generated based on a stereoscopic depth-estimation-based representation the environment (e.g., as described with regard to FIG. 6, FIG. 7, and/or FIG. 8), a monocular vision depth-estimation-based representation the environment, and/or a geometric depth-estimation-based representation the road (e.g., as described with regard to FIG. 8).

Filter 904 may filter depth representation 902 to generate filtered depth representation 906. Filter 904 may filter depth representation 902 by removing noisy depth values and/or outlier depth values from depth representation 902. For example, filter 904 may perform outlier rejection based on a defined gating area and/or Random Sample Consensus (RANSAC). Additionally or alternatively, filter 904 may filter depth representation 902 by removing depth values that do not represent the road from depth representation 902. As such, filtered depth representation 906 may include a depth representation of the road. For example, graph 1008 of FIG. 10 illustrates height values 1010 which may be an example of height values determined from depth representation 902. Further, graph 1012 of FIG. 10 illustrates height values 1016 as dots. Height values 1016 may be an example of filtered depth representation 906.

Returning to FIG. 9, modeler 908 may generate road-height profile 910 based on filtered depth representation 906. For example, modeler 908 may model depth values representative of the road as road-height profile 910.

For example, modeler 908 may apply a least-squares estimation technique to a model of a road-height profile for a given depth representation 902. For example, modeler 908 may define a clothoid model as a road-height-profile model.

The height at certain depths can be defined as follows:

$$height ( x ) = τ x + c \frac{{x}^{2}}{2} + r \frac{{x}^{3}}{6}$$

where x is the depth;
where τ is the road slope as estimated as part of calibration;
where c is curvature; and
r is curvature rate.

Based on this clothoid model and with all the measurements (x, height), values of curvature and curvature rate are then estimated using the least squares method.

Tracker 912 may update road-height profile 910 over time (e.g., based on successive depth representations 902). For example, tracker 912 may apply an extended Kalman filter to generate a more stable road height profile based on several depth representations 902. Road-height profile 1014 of FIG. 10, which is illustrated as a line, illustrates an example of road-height profile 914.

FIG. 10, includes an image 1002 of a road 1004. FIG. 10 also includes a graph 1008 illustrating height values 1010 and a graph 1012 illustrating road-height profile 1014 and height values 1016.

FIG. 11 is a flow diagram illustrating an example process 1100 for combining a first road-height profile and a second road-height profile, according to various aspects of the present disclosure. For example, combiner 128 of FIG. 1 may implement process 1100 to combine road-height profile 116 and road-height profile 126.

The first road-height profile according to the description of process 1100 may refer to a road-height profile determined according to a parallel-lane assumption (e.g., as described with regard to FIG. 3). As such, the first road-height profile may be accurate. However, the first road-height profile may not be completely available. For example, the first road-height profile may include empty height values for certain depths. Additionally or alternatively, the first road-height profile may include invalid height values for certain depths or inaccurate height values for certain depths.

The second road-height profile according to the description of process 1100 may refer to a road-height profile determined based on a depth representation of a scene including a road (e.g., as described with regard to FIG. 5, FIG. 6, FIG. 7, and/or FIG. 8). As such, the second road-height profile may be more available than the first road-height profile. However, in some cases, height values of the first road-height profile may be more accurate than height values of the second road-height profile.

Process 1100 may be repeated a number of times to determine a respective number of height values corresponding to a respective number of depths. For example, process 1100 may be repeated once for each of a number of depths. Each repetition of process 1100 may determine a height value for the depth of the number of depths. Process 1100 may compile a third road-height profile, one height value at a time, based on the first road-height profile and the second road-height profile.

Block 1102 may represent an initial state of process 1100. At block 1102 first and second counters used according to a hysteresis approach to determining a road-height profile may be set to an initialization value, for example, zero.

At decision block 1104, it may be determined whether a height value of the first road-height profile is available for a given depth (e.g., the given depth for which process 1100 is determining a height value). If the height value of the first road-height profile is available, process 1100 may proceed to decision block 1106. If the height value is not available, process 1100 may proceed to decision block 1108.

At decision block 1106, it may be determined whether a height value from the second road-height profile has substantially lower height than the first road-height profile over depth. The height value (of the first road-height profile or the second road-height profile) that is the lower height value of road-height profile may be determined as the better of the two. If the height values of the second road-height profile are lower (in height) over depth, process 1100 may proceed to decision block 1108. If the height value of the second road-height profile is not lower (in height) over depth, process 1100 may proceed to block 1110.

Alternatively, at decision block 1106, it may be determined whether a height value from the second road-height profile is more consistent with the third road-height profile that is being compiled (height value by height value) by process 1100 than a height value from the first road-height profile. For example, a height value from the first road-height profile may be compared to the closest (in depth) height value of the third road-height profile. Further, a height value from the second road-height profile may be compared to the closest (in depth) height value of the third road-height profile. The height value (of the first road-height profile or the second road-height profile) that is more like the closest height value of the third road-height profile may be determined as the better of the two. If the height value of the second road-height profile is closer (in height) to the closest (in depth) height value of the third road-height profile, process 1100 may proceed to decision block 1108. If the height value of the first road-height profile is closer (in height) to the closest (in depth) height value of the third road-height profile, process 1100 may proceed to block 1110.

At decision block 1108, it may be determined whether a height value of the second road-height profile is available for a given depth (e.g., the given depth for which process 1100 is determining a height value). If the height value of the second road-height profile is available, process 1100 may proceed to block 1112. If the height value is not available, process 1100 may proceed to block 1110.

At block 1110 a first counter may be incremented. The first counter may relate to the first road-height profile. For example, the first counter may be used to track how many of a most-recent number (e.g., three) of height values of the first road-height profile have been selected for inclusion in the third road-height profile. Block 1110 may be followed by block 1114.

At block 1112 a second counter may be incremented. The second counter may relate to the second road-height profile. For example, the second counter may be used to track how many of a most-recent number (e.g., three) of height values of the second road-height profile have been selected for inclusion in the third road-height profile. Block 1112 may be followed by block 1114.

At block 1114, a hysteresis approach may be applied based on the first counter and the second counter. Block 1110, the first counter, block 1112, the second counter, and block 1114 may collectively implement a hysteresis approach in process 1100. The hysteresis approach may limit flicker. For example, the hysteresis approach may prevent process 1100 from switching between selecting height values from the first road-height profile then the second road-height profile too frequently. For example, the hysteresis approach may prevent process 1100 from alternating between selecting height values from the first road-height profile then the second road-height profile.

Block 1116 represents outputting the third road-height profile. In some aspects, the third road-height profile may be output after process 1100 has been repeated for a number of depths. In some aspects, the third road-height profile may be output after process 1100 has been repeated for all the height values of the first road-height profile and/or the second road-height profile.

Process 1100 may, by default, select height values from the first road-height profile. In cases in which a height values for a given depth is not available in the first road-height profile, process 1100 may select a height value from the second road-height profile. Additionally or alternatively, in cases in which a height value of the second road-height profile for a given depth provides a flatter road-height profile than a height value of the first road-height profile, process 1100 may select the height value from the second road-height profile rather than from the first road-height profile. Additionally or alternatively, process 1100 may implement a hysteresis approach to limit the frequency of switching between selecting height values from the first road-height profile then the second road-height profile.

An alternative approach to combining the first road-height profile and the second road-height profile (e.g., alternative to process 1100) includes averaging, for each depth, height values of the first road-height profile and the second road-height profile. Another alternative approach includes using a least-squares estimation to determine height values of the third road-height profile based on the height values of the first road-height profile and the second road-height profile.

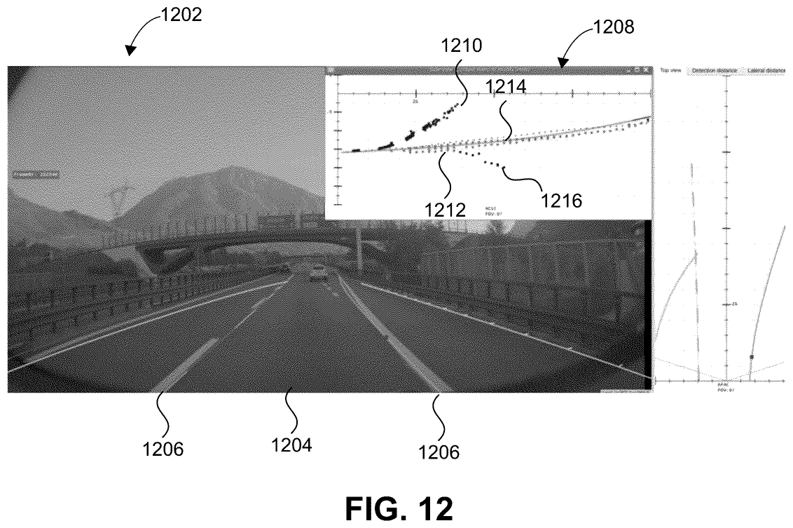

FIG. 12 includes an image 1202 of a road 204 and a graph 1208 of various height values. In particular, graph 1208 illustrates inaccurate height values 1210 which may be determined according to a parallel-lane assumption. In reality, lane boundaries 1206 are not parallel (based on the dividing lane), and thus inaccurate height values 1210 are inaccurate. Graph 1208 also includes height values 1212 which may be determined based on a depth representation of road 1204.

Graph 1208 also includes a road-height profile 1214 that may be determined based on height values 1210 and height values 1212 (e.g., according to process 1100 of FIG. 11). For example, process 1100 may select height values 1212 for inclusion in road-height profile 1214 based on height values 1210 missing values and/or being less consistent (e.g., flat) with already-selected height values of road-height profile 1214. Additionally, graph 1208 includes inaccurate depth measurements 1216 that are identified as outliers.

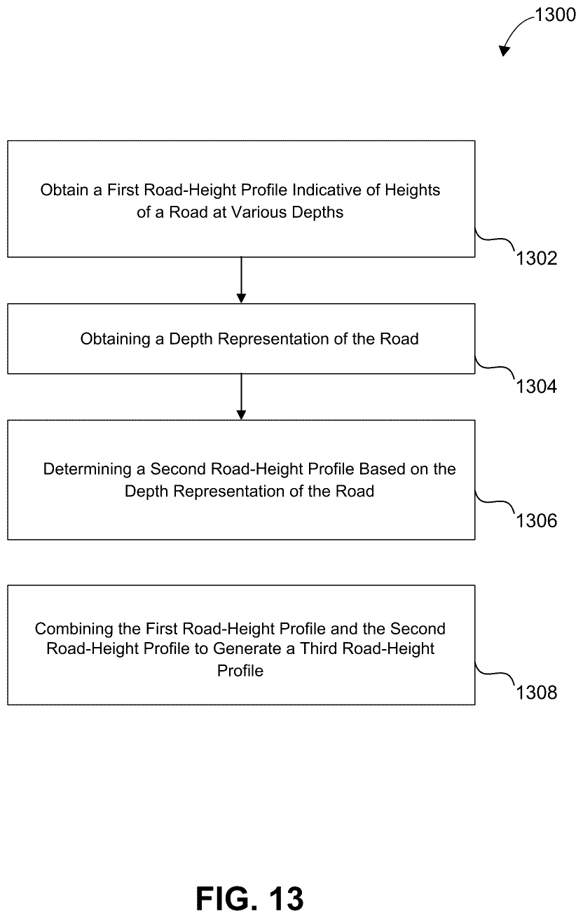

FIG. 13 is a flow diagram illustrating a process 1300 for generating a road-height profile, in accordance with aspects of the present disclosure. One or more operations of process 1300 may be performed by a computing device (or apparatus) or a component (e.g., a chipset, codec, etc.) of the computing device. The computing device may be a mobile device (e.g., a mobile phone), a network-connected wearable such as a watch, an extended reality (x_{R}) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1300. The one or more operations of process 1300 may be implemented as software components that are executed and run on one or more processors.

At block 1302, a computing device (or one or more components thereof) may obtain a first road-height profile indicative of heights of a road at various depths. For example, combiner 128 of system 100 of FIG. 1 may obtain road-height profile 116. Road-height profile 116 may be indicative of heights of a road at various distances between a camera (e.g., of a vehicle) and the road.

In some aspects, the first road-height profile may be based on a parallel-lane assumption. For example, road-height profile 116 of FIG. 1 may be estimated according to a parallel-lane assumption, for example, as described with regard to FIG. 3. In some aspects, to obtain the first road-height profile the computing device (or one or more components thereof) may obtain lane boundaries based on an image of the road; determine a depth corresponding to a point in the image based on an assumed distance between lane boundaries at the point; and determine a road height corresponding to the point based on the point in the image and the depth; wherein the first road-height profile comprises a number of road heights corresponding to a respective number of depths. For example, system 100 of FIG. 1 may obtain image data 104 of a road. Lane-boundary detector 106 may determine lane boundaries 108 based on image data 104. Road-height extractor 110 may determine depths corresponding to points in the image based on an assumed distance between lane boundaries 108 and determine road heights corresponding to the points (e.g., as described with regard to FIG. 3).

In some aspects, the first road-height profile may be based on a clothoid model and may be estimated using a least-squares-estimation technique. For example, road-height profile estimator 114 may generate road-height profile 116 based on a clothoid model and using a least-squares-estimation technique. In some aspects, the computing device (or one or more components thereof) may update the first road-height profile by tracking the first road-height profile over time. For example, road-height profile estimator 114 may track and update road-height profile 116 over time. For example, system 100 may receive image data 104 repeatedly and track and update road-height profile 116 based on the repeating image data 104.

At block 1304, the computing device (or one or more components thereof) may obtain a depth representation of the road. For example, road-height extractor 120 of system 100 of FIG. 1 may obtain depth representation 118.

In some aspects, the depth representation of the road may be based on at least one of: a radio detection and ranging (RADAR)-based representation the road; a light detection and ranging (LIDAR)-based representation the road; a time of flight (ToF) depth-detection-based representation the road; a stereoscopic depth-estimation-based representation the road; a monocular vision depth-estimation-based representation the road; or a geometric depth-estimation-based representation the road. For example, depth representation 118 of FIG. 1 may be based on any of a RADAR-based representation the road; a LIDAR-based representation the road; a ToF depth-detection-based representation the road; a stereoscopic depth-estimation-based representation the road; a monocular vision depth-estimation-based representation the road; or a geometric depth-estimation-based representation the road.

In some aspects, to obtain the depth representation of the road, the computing device (or one or more components thereof) may triangulate three-dimensional positions of points from matched points of sequential image frames, wherein a motion of a camera used to capture the sequential image frames between capturing the sequential image frames is used as a baseline for the triangulating. For example, a system or technique may triangulate three-dimensional positions of points of a scene 806 based on first image 808 and second image 810 and motion of camera 802 between t1 and t2 as illustrated by FIG. 8.

At block 1306, the computing device (or one or more components thereof) may determine a second road-height profile based on the depth representation of the road. For example, road-height profile estimator 124 of system 100 of FIG. 1 may determine road-height profile 126 based on road-height values 122, which is based on depth representation 118.

In some aspects, prior to determining the second road-height profile, the computing device (or one or more components thereof) may filter the depth representation of the road to generate a filtered depth representation of the road, wherein the second road-height profile is determined based on the filtered depth representation of the road. For example, system 900 of

FIG. 9 may filter depth representation 902 using filter 904 to generate filtered depth representation 906. In some aspects, to filter the depth representation of the road, the computing device (or one or more components thereof) may identify depth values of the depth representation of the road that represent the road for inclusion in the filtered depth representation of the road; and/or identify depth values of the depth representation of the road that do not represent the road for exclusion from the filtered depth representation of the road. For example, filter 904 may identify depth values of depth representation 902 for inclusion in filtered depth representation 906 or for exclusion from filtered depth representation 906. In some aspects, to filter the depth representation of the road, the computing device (or one or more components thereof) may identify noisy depth values for exclusion from the filtered depth representation of the road; and/or identify outlier depth values for exclusion from the filtered depth representation of the road. For example, filter 904 may exclude noisy depth values and outlier depth values from filtered depth representation 906.

In some aspects, to determine the second road-height profile, the computing device (or one or more components thereof) may model the second road-height profile based on depth values of the depth representation of the road. For example, system 900 of FIG. 9 may use modeler 908 to model road-height profile 910 based on depth representation 902 or filtered depth representation 906. In some aspects, to model the second road-height profile, the computing device (or one or more components thereof) may define a clothoid model based on a predetermined road slope, an estimated curvature, and an estimated curvature rate. For example, modeler 908 may model road-height profile 910 by defining a clothoid model based on a predetermined road slope, an estimated curvature, and an estimated curvature rate. In some aspects, the second road-height profile is based on a clothoid model and is estimated using a least-squares-estimation technique. For example, modeler 908 may generate road-height profile 910 based on a clothoid model estimated using a least-squares-estimation technique.

In some aspects, the computing device (or one or more components thereof) may update the second road-height profile by tracking the second road-height profile over time. For example, system 900 of FIG. 9 may use tracker 912 to update road-height profile 910 over time (e.g., based on receiving additional instances of depth representation 902 over time).

In some aspects, to determine the second road-height profile, the computing device (or one or more components thereof) may filter the depth representation of the road to generate a filtered depth representation of the road; model the second road-height profile based on depth values of the filtered depth representation of the road; and update the second road-height profile by tracking the second road-height profile over time. For example, to generate road-height profile 914, system 900 of FIG. 9 may filter depth representation 902 at filter 904 to generate filtered depth representation 906, generate road-height profile 910 at modeler 908 based on filtered depth representation 906, and track road-height profile 910 at tracker 912 to generate road-height profile 914.

At block 1308, the computing device (or one or more components thereof) may combine the first road-height profile and the second road-height profile to generate a third road-height profile. For example, combiner 128 may combine road-height profile 116 and road-height profile 126 to generate road-height profile 130.

In some aspects, to combine the first road-height profile and the second road-height profile to generate third road-height profile, the computing device (or one or more components thereof) may determine whether the first road-height profile includes a valid height for a given depth; in response to determining that the first road-height profile includes the valid height for the given depth, store the valid height in the third road-height profile for the given depth; and in response to determining that the first road-height profile does not include a valid height for the given depth, store a height from the second road-height profile in the third road-height profile for the given depth. For example, combiner 128 of FIG. 1 may combine road-height profile 116 and road-height profile 126 according to process 1100 of FIG. 11. For example, for a given depth, combiner 128 may determine whether to store a road-height value of road-height profile 116 or road-height profile 126 based on the availability of the road-height value of road-height profile 116 (e.g., as describe with regard to decision block 1104, and decision block 1108.

In some aspects, to combine the first road-height profile and the second road-height profile to generate third road-height profile, the computing device (or one or more components thereof) determine heights for the third road-height profile based on which of the first road-height profile or the second road-height profile provides a lower height. For example, combiner 128 of FIG. 1 may combine road-height profile 116 and road-height profile 126 according to process 1100 of FIG. 11. For example, for a given depth value, combiner 128 may determine whether to store a road-height value of road-height profile 116 or road-height profile 126 based on which of the road-height value of road-height profile 116 or the road-height profile 126 provides a lower height.

In some aspects, to combine the first road-height profile and the second road-height profile to generate third road-height profile, the computing device (or one or more components thereof) may determine heights for the third road-height profile based on which of the first road-height profile or the second road-height profile provides depths that are more consistent with the third road-height profile. For example, combiner 128 of FIG. 1 may combine road-height profile 116 and road-height profile 126 according to process 1100 of FIG. 11. For example, for a given depth value, combiner 128 may determine whether to store a road-height value of road-height profile 116 or road-height profile 126 based on which of the road-height value of road-height profile 116 or the road-height profile 126 is more consistent with already-included road-height values of road-height profile 130.

In some aspects, the third road-height profile may be, or may include, a number of road heights corresponding to a respective number of depths. In some aspects, the first road-height profile may be, or may include, a number of road heights corresponding to a respective number of depths. In some aspects, the second road-height profile may be, or may include, a number of road heights corresponding to a respective number of depths. For example, road-height profile 210 as graphed on graph 208 of FIG. 2 may be an example any of the first, second, and/or third road-height profiles.

In some aspects, to combine the first road-height profile and the second road-height profile to generate third road-height profile, the computing device (or one or more components thereof) may determine heights for the third road-height profile based on a hysteresis approach to heights of the first road-height profile and heights of the second road-height profile. For example, combiner 128 of FIG. 1 may combine road-height profile 116 and road-height profile 126 according to process 1100 of FIG. 11. For example, combiner 128 may implement block 1110, block 1112, and block 1114 to apply hysteresis to the road-height values selected from road-height profile 116 and road-height profile 126, for example, to prevent flicker in road-height profile 130.

In some aspects, the computing device (or one or more components thereof) may control a vehicle based on the third road-height profile. For example, system 100 may be part of a driving system that may be used to autonomously or semi-autonomously control a vehicle or provide information to a driver driving the vehicle.

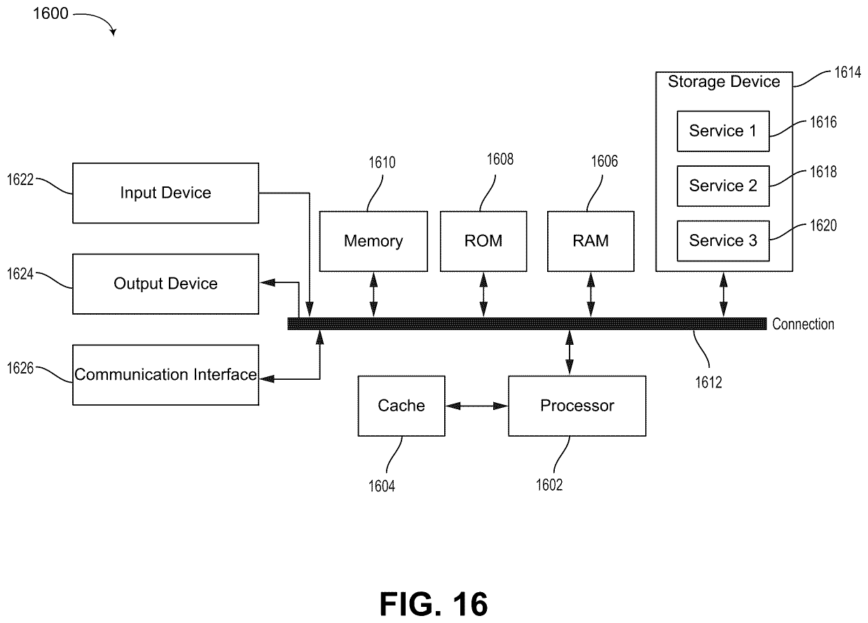

In some examples, as noted previously, the methods described herein (e.g., process 1100 of FIG. 11, process 1300 of FIG. 13, and/or other methods described herein) can be performed, in whole or in part, by a computing device or apparatus. In one example, one or more of the methods can be performed by system 100 of FIG. 1, system 900 of FIG. 9, or by another system or device. In another example, one or more of the methods (e.g., process 1100 of FIG. 11, process 1300 of FIG. 13, and/or other methods described herein) can be performed, in whole or in part, by the computing-device architecture 1600 shown in FIG. 16. For instance, a computing device with the computing-device architecture 1600 shown in FIG. 16 can include, or be included in, the components of the system 100, and/or system 900 and can implement the operations of process 1300, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1100, process 1300, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1100, process 1300, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

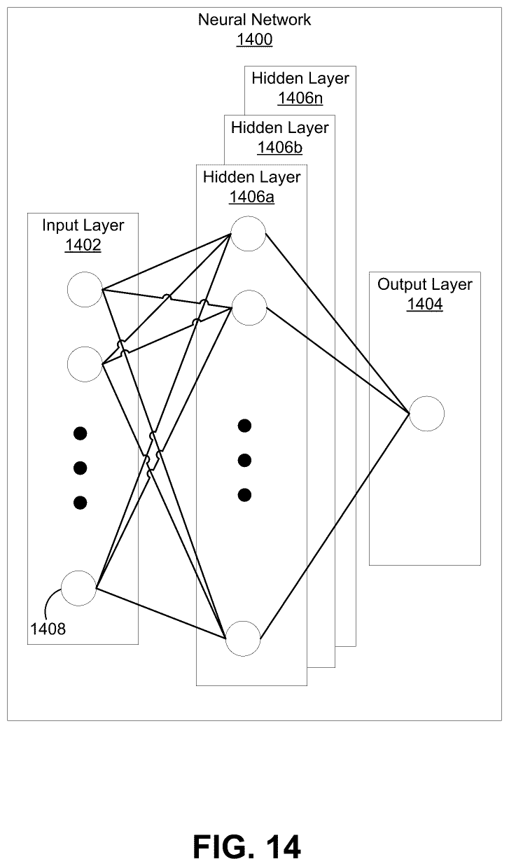

FIG. 14 is an illustrative example of a neural network 1400 (e.g., a deep-learning neural network) that can be used to implement machine-learning based lane detection, feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1400 may be an example of, or can implement, lane-boundary detector 106 of FIG. 1.

An input layer 1402 includes input data. In one illustrative example, input layer 1402 can include data representing image data 104. Neural network 1400 includes multiple hidden layers hidden layers 1406a, 1406b, through 1406n. The hidden layers 1406a, 1406b, through hidden layer 1406n include “n” number of hidden layers, where “n” is an integer greater than or equal to one. The number of hidden layers can be made to include as many layers as needed for the given application. Neural network 1400 further includes an output layer 1404 that provides an output resulting from the processing performed by the hidden layers 1406a, 1406b, through 1406n. In one illustrative example, output layer 1404 can provide lane boundaries 108.

Neural network 1400 may be, or may include, a multi-layer neural network of interconnected nodes. Each node can represent a piece of information. Information associated with the nodes is shared among the different layers and each layer retains information as information is processed. In some cases, neural network 1400 can include a feed-forward network, in which case there are no feedback connections where outputs of the network are fed back into itself. In some cases, neural network 1400 can include a recurrent neural network, which can have loops that allow information to be carried across nodes while reading in input.

Information can be exchanged between nodes through node-to-node interconnections between the various layers. Nodes of input layer 1402 can activate a set of nodes in the first hidden layer 1406a. For example, as shown, each of the input nodes of input layer 1402 is connected to each of the nodes of the first hidden layer 1406a. The nodes of first hidden layer 1406a can transform the information of each input node by applying activation functions to the input node information. The information derived from the transformation can then be passed to and can activate the nodes of the next hidden layer 1406b, which can perform their own designated functions. Example functions include convolutional, up-sampling, data transformation, and/or any other suitable functions. The output of the hidden layer 1406b can then activate nodes of the next hidden layer, and so on. The output of the last hidden layer 1406n can activate one or more nodes of the output layer 1404, at which an output is provided. In some cases, while nodes (e.g., node 1408) in neural network 1400 are shown as having multiple output lines, a node has a single output and all lines shown as being output from a node represent the same output value.

In some cases, each node or interconnection between nodes can have a weight that is a set of parameters derived from the training of neural network 1400. Once neural network 1400 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1400 to be adaptive to inputs and able to learn as more and more data is processed.

Neural network 1400 may be pre-trained to process the features from the data in the input layer 1402 using the different hidden layers 1406a, 1406b, through 1406n in order to provide the output through the output layer 1404. In an example in which neural network 1400 is used to identify features in images, neural network 1400 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1400 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 1400 is trained well enough so that the weights of the layers are accurately tuned.

For the example of identifying objects in images, the forward pass can include passing a training image through neural network 1400. The weights are initially randomized before neural network 1400 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1400, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1400 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½_{(target-output)}². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1400 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 1400 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1400 can include any other deep network other than a CNN, such as an autoencoder, a deep belief nets (DBNs), a Recurrent Neural Networks (RNNs), among others.

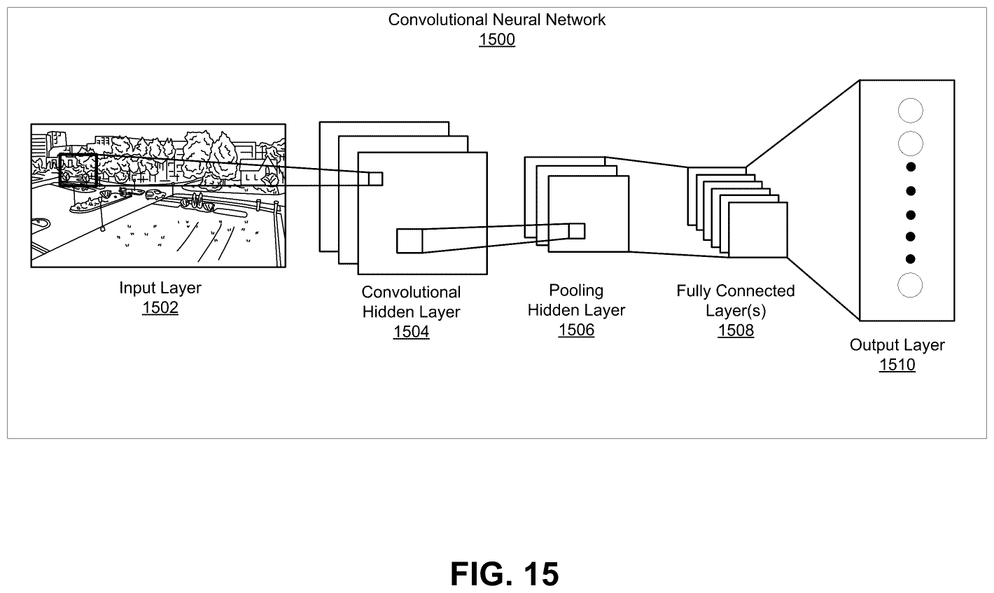

FIG. 15 is an illustrative example of a convolutional neural network (CNN) 1500. The input layer 1502 of the CNN 1500 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1504, an optional non-linear activation layer, a pooling hidden layer 1506, and fully connected layer 1508 (which fully connected layer 1508 can be hidden) to get an output at the output layer 1510. While only one of each hidden layer is shown in FIG. 15, one of ordinary skill will appreciate that multiple convolutional hidden layers, non-linear layers, pooling hidden layers, and/or fully connected layers can be included in the CNN 1500. As previously described, the output can indicate a single class of an object or can include a probability of classes that best describe the object in the image.

The first layer of the CNN 1500 can be the convolutional hidden layer 1504. The convolutional hidden layer 1504 can analyze image data of the input layer 1502. Each node of the convolutional hidden layer 1504 is connected to a region of nodes (pixels) of the input image called a receptive field. The convolutional hidden layer 1504 can be considered as one or more filters (each filter corresponding to a different activation or feature map), with each convolutional iteration of a filter being a node or neuron of the convolutional hidden layer 1504. For example, the region of the input image that a filter covers at each convolutional iteration would be the receptive field for the filter. In one illustrative example, if the input image includes a 28×28 array, and each filter (and corresponding receptive field) is a 5×5 array, then there will be 24x24 nodes in the convolutional hidden layer 1504. Each connection between a node and a receptive field for that node learns a weight and, in some cases, an overall bias such that each node learns to analyze its particular local receptive field in the input image. Each node of the convolutional hidden layer 1504 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1504 is due to each node of the convolutional layer being applied to its corresponding receptive field. For example, a filter of the convolutional hidden layer 1504 can begin in the top-left corner of the input image array and can convolve around the input image. As noted above, each convolutional iteration of the filter can be considered a node or neuron of the convolutional hidden layer 1504. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1504. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1504.

The mapping from the input layer to the convolutional hidden layer 1504 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1504 can include several activation maps in order to identify multiple features in an image. The example shown in FIG. 15 includes three activation maps. Using three activation maps, the convolutional hidden layer 1504 can detect three different kinds of features, with each feature being detectable across the entire image.

In some examples, a non-linear hidden layer can be applied after the convolutional hidden layer 1504. The non-linear layer can be used to introduce non-linearity to a system that has been computing linear operations. One illustrative example of a non-linear layer is a rectified linear unit (ReLU) layer. A ReLU layer can apply the function f(x)=max (0, x) to all of the values in the input volume, which changes all the negative activations to 0. The ReLU can thus increase the non-linear properties of the CNN 1500 without affecting the receptive fields of the convolutional hidden layer 1504.

The pooling hidden layer 1506 can be applied after the convolutional hidden layer 1504 (and after the non-linear hidden layer when used). The pooling hidden layer 1506 is used to simplify the information in the output from the convolutional hidden layer 1504. For example, the pooling hidden layer 1506 can take each activation map output from the convolutional hidden layer 1504 and generates a condensed activation map (or feature map) using a pooling function. Max-pooling is one example of a function performed by a pooling hidden layer. Other forms of pooling functions be used by the pooling hidden layer 1506, such as average pooling, L2-norm pooling, or other suitable pooling functions. A pooling function (e.g., a max-pooling filter, an L2-norm filter, or other suitable pooling filter) is applied to each activation map included in the convolutional hidden layer 1504. In the example shown in FIG. 15, three pooling filters are used for the three activation maps in the convolutional hidden layer 1504.

In some examples, max-pooling can be used by applying a max-pooling filter (e.g., having a size of 2×2) with a stride (e.g., equal to a dimension of the filter, such as a stride of 2) to an activation map output from the convolutional hidden layer 1504. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1504 having a dimension of 24×24 nodes, the output from the pooling hidden layer 1506 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1500.

The final layer of connections in the network is a fully-connected layer that connects every node from the pooling hidden layer 1506 to every one of the output nodes in the output layer 1510. Using the example above, the input layer includes 28×28 nodes encoding the pixel intensities of the input image, the convolutional hidden layer 1504 includes 3×24×24 hidden feature nodes based on application of a 5×5 local receptive field (for the filters) to three activation maps, and the pooling hidden layer 1506 includes a layer of 3×12×12 hidden feature nodes based on application of max-pooling filter to 2×2 regions across each of the three feature maps. Extending this example, the output layer 1510 can include ten output nodes. In such an example, every node of the 3×12×12 pooling hidden layer 1506 is connected to every node of the output layer 1510.

The fully connected layer 1508 can obtain the output of the previous pooling hidden layer 1506 (which should represent the activation maps of high-level features) and determines the features that most correlate to a particular class. For example, the fully connected layer 1508 can determine the high-level features that most strongly correlate to a particular class and can include weights (nodes) for the high-level features. A product can be computed between the weights of the fully connected layer 1508 and the pooling hidden layer 1506 to obtain probabilities for the different classes. For example, if the CNN 1500 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1510 can include an M-dimensional vector (in the prior example, M=10). M indicates the number of classes that the CNN 1500 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 16 illustrates an example computing-device architecture 1600 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1600 may include, implement, or be included in any or all of system 100 of FIG. 1, system 900 of FIG. 9. Additionally or alternatively, computing-device architecture 1600 may be configured to perform process 1300, and/or other process described herein.

The components of computing-device architecture 1600 are shown in electrical communication with each other using connection 1612, such as a bus. The example computing-device architecture 1600 includes a processing unit (CPU or processor) 1602 and computing device connection 1612 that couples various computing device components including computing device memory 1610, such as read only memory (ROM) 1608 and random-access memory (RAM) 1606, to processor 1602.

Computing-device architecture 1600 can include a cache of high-speed memory connected directly with, in close proximity to, or integrated as part of processor 1602. Computing-device architecture 1600 can copy data from memory 1610 and/or the storage device 1614 to cache 1604 for quick access by processor 1602. In this way, the cache can provide a performance boost that avoids processor 1602 delays while waiting for data. These and other modules can control or be configured to control processor 1602 to perform various actions. Other computing device memory 1610 may be available for use as well. Memory 1610 can include multiple different types of memory with different performance characteristics. Processor 1602 can include any general-purpose processor and a hardware or software service, such as service 1 1616, service 2 1618, and service 3 1620 stored in storage device 1614, configured to control processor 1602 as well as a special-purpose processor where software instructions are incorporated into the processor design. Processor 1602 may be a self-contained system, containing multiple cores or processors, a bus, memory controller, cache, etc. A multi-core processor may be symmetric or asymmetric.

To enable user interaction with the computing-device architecture 1600, input device 1622 can represent any number of input mechanisms, such as a microphone for speech, a touch-sensitive screen for gesture or graphical input, keyboard, mouse, motion input, speech and so forth. Output device 1624 can also be one or more of a number of output mechanisms known to those of skill in the art, such as a display, projector, television, speaker device, etc. In some instances, multimodal computing devices can enable a user to provide multiple types of input to communicate with computing-device architecture 1600. Communication interface 1626 can generally govern and manage the user input and computing device output. There is no restriction on operating on any particular hardware arrangement and therefore the basic features here may easily be substituted for improved hardware or firmware arrangements as they are developed.

Storage device 1614 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1606, read only memory (ROM) 1608, and hybrids thereof. Storage device 1614 can include services 1616, 1618, and 1620 for controlling processor 1602. Other hardware or software modules are contemplated. Storage device 1614 can be connected to the computing device connection 1612. In one aspect, a hardware module that performs a particular function can include the software component stored in a computer-readable medium in connection with the necessary hardware components, such as processor 1602, connection 1612, output device 1624, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for determining height information of a road, the apparatus comprising: at least one memory; and at least one processor coupled to the at least one memory and configured to: obtain a first road-height profile indicative of heights of a road at various depths; obtain a depth representation of the road; determine a second road-height profile based on the depth representation of the road; and combine the first road-height profile and the second road-height profile to generate a third road-height profile.
Aspect 2. The apparatus of aspect 1, wherein the third road-height profile comprises a number of road heights corresponding to a respective number of depths.
Aspect 3. The apparatus of any one of aspects 1 or 2, wherein the at least one processor is further configured to, prior to determining the second road-height profile, filter the depth representation of the road to generate a filtered depth representation of the road, wherein the second road-height profile is determined based on the filtered depth representation of the road.
Aspect 4. The apparatus of aspect 3, wherein, to filter the depth representation of the road, the at least one processor is configured to at least one of: identify depth values of the depth representation of the road that represent the road for inclusion in the filtered depth representation of the road; or identify depth values of the depth representation of the road that do not represent the road for exclusion from the filtered depth representation of the road.
Aspect 5. The apparatus of any one of aspects 3 or 4, wherein, to filter the depth representation of the road, the at least one processor is configured to at least one of: identify noisy depth values for exclusion from the filtered depth representation of the road; or identify outlier depth values for exclusion from the filtered depth representation of the road.
Aspect 6. The apparatus of any one of aspects 1 to 5, wherein, to determine the second road-height profile, the at least one processor is configured to model the second road-height profile based on depth values of the depth representation of the road.
Aspect 7. The apparatus of aspect 6, wherein, to model the second road-height profile, the at least one processor is configured to define a clothoid model based on a predetermined road slope, an estimated curvature, and an estimated curvature rate.
Aspect 8. The apparatus of any one of aspects 6 or 7, wherein the second road-height profile is based on a clothoid model and is estimated using a least-squares-estimation technique.
Aspect 9. The apparatus of any one of aspects 1 to 8, wherein the at least one processor is further configured to update the second road-height profile by tracking the second road-height profile over time.
Aspect 10. The apparatus of any one of aspects 1 to 9, wherein, to determine the second road-height profile, the at least one processor is configured to: filter the depth representation of the road to generate a filtered depth representation of the road; model the second road-height profile based on depth values of the filtered depth representation of the road; and update the second road-height profile by tracking the second road-height profile over time.
Aspect 11. The apparatus of any one of aspects 1 to 10, wherein, to combine the first road-height profile and the second road-height profile to generate third road-height profile, the at least one processor is configured to: determine whether the first road-height profile includes a valid height for a given depth; in response to determining that the first road-height profile includes the valid height for the given depth, store the valid height in the third road-height profile for the given depth; and in response to determining that the first road-height profile does not include a valid height for the given depth, store a height from the second road-height profile in the third road-height profile for the given depth.
Aspect 12. The apparatus of any one of aspects 1 to 11, wherein, to combine the first road-height profile and the second road-height profile to generate third road-height profile, the at least one processor is configured to determine heights for the third road-height profile based on which of the first road-height profile or the second road-height profile provides a lower height.
Aspect 13. The apparatus of any one of aspects 1 to 12, wherein, to combine the first road-height profile and the second road-height profile to generate third road-height profile, the at least one processor is configured to determine heights for the third road-height profile based on which of the first road-height profile or the second road-height profile provides depths that are more consistent with the third road-height profile.
Aspect 14. The apparatus of any one of aspects 1 to 13, wherein, to combine the first road-height profile and the second road-height profile to generate third road-height profile, the at least one processor is configured to determine heights for the third road-height profile based on a hysteresis approach to heights of the first road-height profile and heights of the second road-height profile.
Aspect 15. The apparatus of any one of aspects 1 to 14, wherein the depth representation of the road is based on at least one of: a radio detection and ranging (RADAR)-based representation the road; a light detection and ranging (LIDAR)-based representation the road; a time of flight (ToF) depth-detection-based representation the road; a stereoscopic depth-estimation-based representation the road; a monocular vision depth-estimation-based representation the road; or a geometric depth-estimation-based representation the road.
Aspect 16. The apparatus of any one of aspects 1 to 15, wherein, to obtain the depth representation of the road, the at least one processor is configured to triangulate three-dimensional positions of points from matched points of sequential image frames, wherein a motion of a camera used to capture the sequential image frames between capturing the sequential image frames is used as a baseline for the triangulating.
Aspect 17. The apparatus of any one of aspects 1 to 16, wherein the first road-height profile is based on a parallel-lane assumption.
Aspect 18. The apparatus of any one of aspects 1 to 17, wherein, to obtain the first road-height profile the at least one processor is configured to: obtain lane boundaries based on an image of the road; determine a depth corresponding to a point in the image based on an assumed distance between lane boundaries at the point; and determine a road height corresponding to the point based on the point in the image and the depth; wherein the first road-height profile comprises a number of road heights corresponding to a respective number of depths.
Aspect 19. The apparatus of any one of aspects 1 to 18, wherein the first road-height profile is based on a clothoid model and is estimated using a least-squares-estimation technique.
Aspect 20. The apparatus of any one of aspects 1 to 19, wherein the at least one processor is further configured to update the first road-height profile by tracking the first road-height profile over time.
Aspect 21. The apparatus of any one of aspects 1 to 20, wherein the at least one processor is further configured to control a vehicle based on the third road-height profile.
Aspect 22. A method for determining height information of a road, the method comprising: obtaining a first road-height profile indicative of heights of a road at various depths; obtaining a depth representation of the road; determining a second road-height profile based on the depth representation of the road; and combining the first road-height profile and the second road-height profile to generate a third road-height profile.
Aspect 23. The method of aspect 22, wherein the third road-height profile comprises a number of road heights corresponding to a respective number of depths.
Aspect 24. The method of any one of aspects 22 or 23, further comprising, prior to determining the second road-height profile, filtering the depth representation of the road to generate a filtered depth representation of the road, wherein the second road-height profile is determined based on the filtered depth representation of the road.
Aspect 25. The method of aspect 24, wherein filtering the depth representation of the road comprises at least one of: identifying depth values of the depth representation of the road that represent the road for inclusion in the filtered depth representation of the road; or identifying depth values of the depth representation of the road that do not represent the road for exclusion from the filtered depth representation of the road.
Aspect 26. The method of any one of aspects 24 or 25, wherein filtering the depth representation of the road comprises at least one of: identifying noisy depth values for exclusion from the filtered depth representation of the road; or identifying outlier depth values for exclusion from the filtered depth representation of the road.
Aspect 27. The method of any one of aspects 22 to 26, wherein determining the second road-height profile comprises modeling the second road-height profile based on depth values of the depth representation of the road.
Aspect 28. The method of aspect 27, wherein modeling the second road-height profile comprises defining a clothoid model based on a predetermined road slope, an estimated curvature, and an estimated curvature rate.
Aspect 29. The method of any one of aspects 27 or 28, wherein the second road-height profile is based on a clothoid model and is estimated using a least-squares-estimation technique.
Aspect 30. The method of any one of aspects 22 to 29, further comprising updating the second road-height profile by tracking the second road-height profile over time.
Aspect 31. The method of any one of aspects 22 to 30, wherein determining the second road-height profile comprises: filtering the depth representation of the road to generate a filtered depth representation of the road; modeling the second road-height profile based on depth values of the filtered depth representation of the road; and updating the second road-height profile by tracking the second road-height profile over time.
Aspect 32. The method of any one of aspects 22 to 31, wherein combining the first road-height profile and the second road-height profile to generate third road-height profile comprises: determining whether the first road-height profile includes a valid height for a given depth; in response to determining that the first road-height profile includes the valid height for the given depth, storing the valid height in the third road-height profile for the given depth; and in response to determining that the first road-height profile does not include a valid height for the given depth, storing a height from the second road-height profile in the third road-height profile for the given depth.
Aspect 33. The method of any one of aspects 22 to 32, wherein combining the first road-height profile and the second road-height profile to generate third road-height profile comprises determining heights for the third road-height profile based on which of the first road-height profile or the second road-height profile provides a lower height.
Aspect 34. The method of any one of aspects 22 to 33, wherein combining the first road-height profile and the second road-height profile to generate third road-height profile comprises determining heights for the third road-height profile based on which of the first road-height profile or the second road-height profile provides depths that are more consistent with the third road-height profile.
Aspect 35. The method of any one of aspects 22 to 34, wherein combining the first road-height profile and the second road-height profile to generate third road-height profile comprises determining heights for the third road-height profile based on a hysteresis approach to heights of the first road-height profile and heights of the second road-height profile.
Aspect 36. The method of any one of aspects 22 to 35, wherein the depth representation of the road is based on at least one of: a radio detection and ranging (RADAR)-based representation the road; a light detection and ranging (LIDAR)-based representation the road; a time of flight (ToF) depth-detection-based representation the road; a stereoscopic depth-estimation-based representation the road; a monocular vision depth-estimation-based representation the road; or a geometric depth-estimation-based representation the road.
Aspect 37. The method of any one of aspects 22 to 36, wherein obtaining the depth representation of the road comprises triangulating three-dimensional positions of points from matched points of sequential image frames, wherein a motion of a camera used to capture the sequential image frames between capturing the sequential image frames is used as a baseline for the triangulating.
Aspect 38. The method of any one of aspects 22 to 37, wherein the first road-height profile is based on a parallel-lane assumption.
Aspect 39. The method of any one of aspects 22 to 38, wherein obtaining the first road-height profile comprises: obtaining lane boundaries based on an image of the road; determining a depth corresponding to a point in the image based on an assumed distance between lane boundaries at the point; and determining a road height corresponding to the point based on the point in the image and the depth; wherein the first road-height profile comprises a number of road heights corresponding to a respective number of depths.
Aspect 40. The method of any one of aspects 22 to 39, wherein the first road-height profile is based on a clothoid model and is estimated using a least-squares-estimation technique.
Aspect 41. The method of any one of aspects 22 to 40, further comprising updating the first road-height profile by tracking the first road-height profile over time.
Aspect 42. The method of any one of aspects 22 to 41, further comprising controlling a vehicle based on the third road-height profile.
Aspect 43. A non-transitory computer-readable storage medium having stored thereon instructions that, when executed by at least one processor, cause the at least one processor to perform operations according to any of aspects 22 to 42.
Aspect 44. An apparatus for providing virtual content for display, the apparatus comprising one or more means for perform operations according to any of aspects 22 to 42.

What is claimed is:

1. An apparatus for determining height information of a road, the apparatus comprising:
at least one memory; and
at least one processor coupled to the at least one memory and configured to:
obtain a first road-height profile indicative of heights of a road at various depths;
obtain a depth representation of the road;
determine a second road-height profile based on the depth representation of the road; and
combine the first road-height profile and the second road-height profile to generate a third road-height profile.

2. The apparatus of claim 1, wherein the third road-height profile comprises a number of road heights corresponding to a respective number of depths.

3. The apparatus of claim 1, wherein the at least one processor is further configured to, prior to determining the second road-height profile, filter the depth representation of the road to generate a filtered depth representation of the road, wherein the second road-height profile is determined based on the filtered depth representation of the road.

4. The apparatus of claim 3, wherein, to filter the depth representation of the road, the at least one processor is configured to at least one of:
identify depth values of the depth representation of the road that represent the road for inclusion in the filtered depth representation of the road; or
identify depth values of the depth representation of the road that do not represent the road for exclusion from the filtered depth representation of the road.

5. The apparatus of claim 3, wherein, to filter the depth representation of the road, the at least one processor is configured to at least one of:
identify noisy depth values for exclusion from the filtered depth representation of the road; or
identify outlier depth values for exclusion from the filtered depth representation of the road.

6. The apparatus of claim 1, wherein, to determine the second road-height profile, the at least one processor is configured to model the second road-height profile based on depth values of the depth representation of the road.

7. The apparatus of claim 6, wherein, to model the second road-height profile, the at least one processor is configured to define a clothoid model based on a predetermined road slope, an estimated curvature, and an estimated curvature rate.

8. The apparatus of claim 6, wherein the second road-height profile is based on a clothoid model and is estimated using a least-squares-estimation technique.

9. The apparatus of claim 1, wherein the at least one processor is further configured to update the second road-height profile by tracking the second road-height profile over time.

10. The apparatus of claim 1, wherein, to determine the second road-height profile, the at least one processor is configured to:
filter the depth representation of the road to generate a filtered depth representation of the road;
model the second road-height profile based on depth values of the filtered depth representation of the road; and
update the second road-height profile by tracking the second road-height profile over time.

11. The apparatus of claim 1, wherein, to combine the first road-height profile and the second road-height profile to generate third road-height profile, the at least one processor is configured to:
determine whether the first road-height profile includes a valid height for a given depth;
in response to determining that the first road-height profile includes the valid height for the given depth, store the valid height in the third road-height profile for the given depth; and
in response to determining that the first road-height profile does not include a valid height for the given depth, store a height from the second road-height profile in the third road-height profile for the given depth.

12. The apparatus of claim 1, wherein, to combine the first road-height profile and the second road-height profile to generate third road-height profile, the at least one processor is configured to determine heights for the third road-height profile based on which of the first road-height profile or the second road-height profile provides a lower height.

13. The apparatus of claim 1, wherein, to combine the first road-height profile and the second road-height profile to generate third road-height profile, the at least one processor is configured to determine heights for the third road-height profile based on which of the first road-height profile or the second road-height profile provides depths that are more consistent with the third road-height profile.

14. The apparatus of claim 1, wherein, to combine the first road-height profile and the second road-height profile to generate third road-height profile, the at least one processor is configured to determine heights for the third road-height profile based on a hysteresis approach to heights of the first road-height profile and heights of the second road-height profile.

15. The apparatus of claim 1, wherein the depth representation of the road is based on at least one of:
a radio detection and ranging (RADAR)-based representation the road;
a light detection and ranging (LIDAR)-based representation the road;
a time of flight (ToF) depth-detection-based representation the road;
a stereoscopic depth-estimation-based representation the road;
a monocular vision depth-estimation-based representation the road; or
a geometric depth-estimation-based representation the road.

16. The apparatus of claim 1, wherein, to obtain the depth representation of the road, the at least one processor is configured to triangulate three-dimensional positions of points from matched points of sequential image frames, wherein a motion of a camera used to capture the sequential image frames between capturing the sequential image frames is used as a baseline for the triangulating.

17. The apparatus of claim 1, wherein the first road-height profile is based on a parallel-lane assumption.

18. The apparatus of claim 1, wherein, to obtain the first road-height profile the at least one processor is configured to:
obtain lane boundaries based on an image of the road;
determine a depth corresponding to a point in the image based on an assumed distance between lane boundaries at the point; and
determine a road height corresponding to the point based on the point in the image and the depth;
wherein the first road-height profile comprises a number of road heights corresponding to a respective number of depths.

19. The apparatus of claim 1, wherein the first road-height profile is based on a clothoid model and is estimated using a least-squares-estimation technique.

20. The apparatus of claim 1, wherein the at least one processor is further configured to update the first road-height profile by tracking the first road-height profile over time.
